(19) United States
(12) Patent Application Publication
(10) Pub. No.: US 2006/0261583 A1
(43) Pub. Date: Nov. 23, 2006

(54) Airbag module

(75) Inventors: Jens Debler, Herlikofen (DE); Joachim Lutz, Schechingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/435,078

(22) Filed: May 16, 2006

(30) Foreign Application Priority Data
May 18, 2005 (DE) 10 2005 022 760.0

(51) Int. Cl. B60R 21/26

(52) U.S. Cl. 280/740; 280/736

(57) ABSTRACT

Pyrotechnical fuel contained in a gas generator of an airbag module accommodated in a module housing self-ignites at a predetermined temperature elevated above normal ambient temperatures. A module housing of the airbag module has a wall section with a predetermined opening closed with respect to gas flow at normal ambient temperatures. The gas generator has at least a first outflow opening and a second outflow opening, the second outflow opening being closed when the gas generator is actuated at normal ambient temperatures. The wall section of the module housing is designed in such a way that on self-ignition of the pyrotechnical fuel at at least the predetermines temperature, the predetermined opening is created in the wall section, and the second outflow opening is opened with respect to gas flow by creation of the predetermined opening.

### FIELD OF THE INVENTION

The invention relates to an airbag module.

### BACKGROUND OF THE INVENTION

Airbags which are filled with pressurized gas by a gas generator in case of an accident in order to prevent the vehicle occupant from coming into contact with vehicle parts, have meanwhile become standard in cars. In order to ensure that vehicle occupants or rescue workers are not put in danger by a gas generator if the vehicle catches fire, gas generators must be subjected to the so-called ‘bonfire test’ of the German Federal Institute for Materials Testing, in which a gas generator is exposed to an increased ambient temperature of approximately 100 to 180° C. for an extended period of time. The gas generator must be designed such that the gas-producing material contained therein self-ignites and burns in a controlled manner.

It is an object of the invention to provide an airbag module which has good airbag inflation characteristics, is inexpensive to produce and yet offers a high level of safety under bonfire conditions.

### BRIEF SUMMARY OF THE INVENTION

This is achieved in an airbag module comprising a module housing and a gas generator. Pyrotechnical fuel contained in the gas generator accommodated in the module housing self-ignites at a predetermined temperature elevated above normal ambient temperatures. The module housing has a wall section with a predetermined opening closed with respect to gas flow at normal ambient temperatures. The gas generator has at least a first outflow opening and a second outflow opening, the second outflow opening being closed when the gas generator is actuated at normal ambient temperatures (i.e. when there is a normal release in the case of an accident). The wall section of the module housing is designed in such a way that on self-ignition of the pyrotechnical fuel at at least the predetermined temperature (e.g. during a bonfire test), the predetermined opening is created in the wall section, and the second outflow opening is opened with respect to gas flow by creation of the predetermined opening. In this way, on the one hand thrust neutrality of the gas generator can be fully or partially achieved or re-produced. However, on the other hand, because the module housing opens, a large part of the resulting gas is also conveyed directly out of the airbag module so that the airbag does not necessarily unfold.

In the following, and for the sake of simplicity, one will only talk of a first and a second outflow opening. However, designs comprising several first and second outflow openings, respectively, or else one or more areas with several outflow openings each, as is known with conventional gas generators are also falling under the scope of the invention.

Preferably, the wall section is made from a plastic material. The choice is made with regard to material and thickness such that under the conditions of a bonfire test, a predetermined softening or a melting of the wall section occurs. When the fuel self-ignites, the gas pressure in the gas generator is then preferably sufficient in order to move the wall in an outward direction and to create the predetermined opening. If the wall section has already melted away, the predetermined opening is created in this way.

The wall section can pass into an adjacent wall area without any change in thickness of the wall. There is no need, therefore, to provide any weakened zones such as tear lines or similar which would increase the production costs of the module housing.

Advantageously, when the second outflow opening is open, the gas generator shows thrust-neutral outflow behavior. A gas generator which is thrust-neutral in itself can therefore be used, in which one or more outflow openings are closed when it is inserted into the module housing. These are normally those outflow openings which face away from the airbag. In order to inflate the airbag, the gas only flows through the first outflow opening into the airbag, and fills it. Only under bonfire conditions when the module housing opens and the second outflow opening is opened does the gas generator regain its thrust neutrality.

In a preferred embodiment of the invention, the second outflow opening is closed by a closure means, and the closure means is released from the second outflow opening when the predetermined opening in the wall section is created. When released under normal ambient temperatures, gas only flows out of the gas generator through the first outflow opening.

Preferably, the closure means is a separate component from the gas generator and the module housing.

If the closure means is positioned between the gas generator and the wall section, additional attachments for the closure means do not necessarily have to be provided.

The closure means can be e.g. plate-shaped or in the form of a plug. Similarly to the wall section, it is beneficial if the closure means is made from a plastic material. Then, at a predetermined temperature elevated above normal ambient temperatures as occur e.g. under the conditions of a bonfire test, the closure means can soften or melt, meaning that there is little or no resistance to the opening of the second outflow opening under the gas pressure which is produced when the fuel in the gas generator self-ignites.

### BRIEF DESCRIPTION OF THE DRAWINGS

FIG. 1 shows a schematic section through an airbag module in accordance with the invention according to a first embodiment when activated at normal ambient temperature;

FIG. 2 shows the airbag module from FIG. 1 when activated at a predetermined temperature elevated above normal ambient temperature;

FIG. 3 shows a schematic section through an airbag module in accordance with the invention according to a second embodiment when activated at normal ambient temperature; and

FIG. 4 shows the airbag module from FIG. 3 when activated at a predetermined temperature elevated above normal ambient temperature.

### DETAILED DESCRIPTION OF A PREFERRED EMBODIMENT

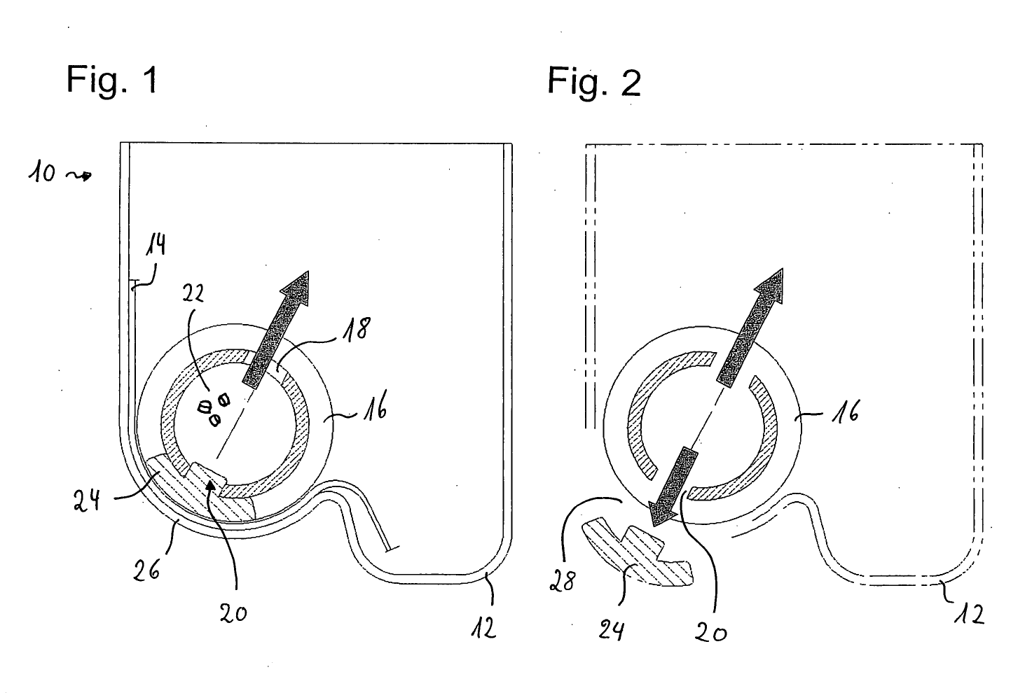

FIG. 1 shows an airbag module 10 in accordance with a first embodiment. In a trough-shaped module housing 12 made from a plastic material, an airbag 14 is accommodated which, prior to activation of the airbag module 10, is arranged folded in the module housing 12. In the module housing 12 and in the airbag 14 is contained a gas generator 16, here an elongated tubular gas generator, which has a first outflow opening 18 and a second outflow opening 20 lying diametrically opposed to each other. The terms “first” and “second” outflow opening are to be understood as meaning that these could also include one or more groups of outflow openings which are arranged corresponding to the first and second outflow openings 18, 20 shown.

The gas generator 16 per se (i.e. before installation) is thrust-neutral, i.e. when pyrotechnical fuel 22 contained inside (indicated here by the tablets in FIG. 1) is ignited, the gas produced flows out through the outflow openings 18, 20 such that the gas generator 16 does not receive any momentum generating a movement of the gas generator 16.

Before the gas generator 16 is inserted into the module housing 12, the second outflow opening 20, however, is closed gas-tightly by a closure means, in this embodiment in the form of a plug 24 made from a thermoplastic synthetic. A projection of the plug 24 protrudes through the second outflow opening 20 into the interior of the gas generator 16 and is wedged into the outflow opening 20. A section of the plug 24 which surrounds the projection lies between the outer wall of the gas generator 16 and a wall section 26 of the module housing 12 and butts against both the outer wall of the gas generator 16 and the inner wall of the module housing 12 in the area of the wall section 26. The wall section 26 defines the area of the wall of the module housing 12 which lies directly adjacent to the second outflow opening 20.

If several outflow openings corresponding to the second outflow opening 20 are provided, these are all at first correspondingly closed by one or more closure means in this embodiment, even though just one closure means is shown here.

When the airbag module 10 is activated in the case of an accident at a normal ambient temperature (i.e. approximately −40 to +80° C.), as shown in FIG. 1, the fuel 22 is ignited by an igniter (not shown), and develops gas. The gas leaves the gas generator 16 through the first outflow opening 18 (see arrow in FIG. 1), streaming into the airbag 14.

The second outflow opening 20 remains closed, gas-tight, by means of the plug 24 which is held in position by the wall of the module housing 12. The gas flowing out fills the airbag 14 and unfolds it in the known manner.

FIG. 2 shows the airbag module 10 at increased ambient temperatures corresponding to a predetermined temperature elevated above normal ambient temperatures (about 100 to 180° C.), as occurs e.g. over an extended period during a bonfire test. The whole module housing 12 or just the wall section 26 is made from an appropriate thermoplastic synthetic which softens, or even liquefies under these conditions. At the predetermined temperature, after a certain length of time, the fuel 22 inside the gas generator 16 self-ignites. Because the wall section 26 can no longer put up any significant resistance to the gas pressure due to the softening or liquefaction, the plug 24 is pushed out of the second outflow opening 20 by the gas pressure, and the module housing 12 is pushed open in the area of the wall section 26 such that a predetermined opening 28 is created (at the point where the wall section 26 shown in FIG. 1 had been). In this way, the second outflow opening 20 is opened, and gas can also flow out therethrough.

In the embodiment shown, the plug 24 is also made from a thermoplastic synthetic with the same properties. At the predetermined temperature, i.e. under bonfire test conditions, the material of the plug 24 softens or liquefies. In this way, the plug 24 is removed from the second outflow opening 20 by the gas pressure, without any significant resistance. The gas generator 16 is now thrust-neutral once again. In addition, part of the gas leaves the module housing 12 without flowing into the airbag 14. (The airbag 14 has been omitted from FIG. 2 for reasons of clarity).

In the airbag 14, e.g. a tear line can be provided In the area of the wall section 26 so that the airbag 14 also opens to allow the plug 24 to break free from the gas generator 16. Alternatively, the airbag fabric can also soften or even melt such that its resistance is easily overcome by the gas pressure inside the gas generator 16.

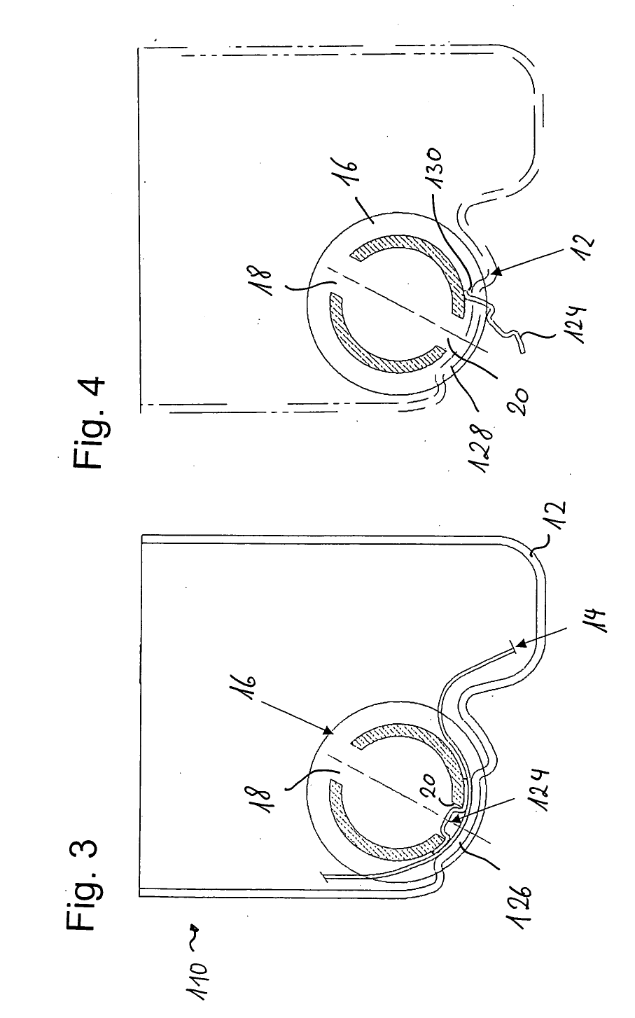

In FIGS. 3 and 4, a second embodiment of an airbag module 110 is shown.

The design is very similar to that of the first embodiment which has just been described. However, the closure means here is in the form of a plate 124 which has a projection protruding into the second outflow opening 20. The plate 124 can be made from a sheet metal or a plastic material which softens or partially melts.

The wall section 126 is adapted to the form of the closure means so that the plate 124 is secured between the outer wall of the gas generator 16 and the wall of the module housing 12.

Similarly to the first embodiment, the plastic material of the module housing 12 softens or melts when a high ambient temperature takes effect under bonfire conditions, so that when there is a self-ignition or intended ignition of the gas-producing fuel 22 (see FIG. 1), the wall section 126 opens under the gas pressure prevailing on the inside of the gas generator 16, and an opening 128 is created. The plate 124 is permanently attached on one side 130 to the gas generator 16, e.g. by means of a hinge, and now swings open outwards so that the second outflow opening 20 is opened. The gas flows in the cases shown in FIGS. 3 and 4 are similar to those in FIGS. 1 and 2.

In the embodiments shown, there is no difference between the wall section 26, 126 and the directly adjacent wall regions of the module housing 12 with regard to material and wall thickness. In particular, no tear line or other weakened zones are provided, and the wall thickness is the same.

However, it is also conceivable to use known weakened zones or to design the wall section 26, 126 to be thinner than the rest of the module housing 12.

The module housing 12 could also be made from two or more different plastic material, a material with a low softening or melting temperature being used for the wall section 26, 126, whereas the rest of the module housing 12 is made from a material with a higher softening or melting temperature so that it still maintains its stability under the bonfire test conditions.

In both embodiments shown, the closure means is a separate component from the gas generator 16 and the module housing 12. It would also be possible, however, to form the wall section 26, 126 in such a way that a projection of the wall section 26, 126 itself at first engages in the second outflow opening 20, and closes it so that it is at least largely gas-tight. A separate closure means could then be dispensed with.

The airbag module 10, 110 shown can be installed e.g. on the front seat passenger side of a car. Other possibilities for use are conceivable, of course, and in the same way, the principle of the invention can be transferred to other airbag modules with different forms of housing or gas generator. In the same way, the individual features of both embodiments can be exchanged or combined by an expert in the field as required.

1. An airbag module comprising:
a module housing (12) having a wall section (26; 126) with a predetermined opening (28) that is closed with respect to gas flow at normal ambient temperatures and
a gas generator (16) accommodated in the module housing (12), the gas generator (16) containing a pyrotechnical fuel (22) self-igniting at a predetermined temperature elevated above normal ambient temperatures,
the gas generator (16) having at least a first outflow opening (18) and a second outflow opening (20), the second outflow opening (20) being closed when the gas generator (16) is actuated at normal ambient temperatures,
the wall section (26; 126) of the module housing (12) being designed in such a way that on self-ignition of the pyrotechnical fuel (22) at at least the predetermines temperature, the predetermined opening (28) is created in the wall section (26; 126)
the second outflow opening (20) being opened with respect to gas flow by creation of the predetermined opening (28).

2. The airbag module according to claim 1, wherein the wall section (26; 126) is made from a plastic material.

3. The airbag module according to claim 1, wherein under the conditions of a bonfire test, a softening or a melting of the wall section (26; 126) occurs.

4. The airbag module according to claim 1, wherein the wall section (26; 126) passes into an adjacent wall area without any change to the wall thickness.

5. The airbag module according to claim 1, wherein, when the second outflow opening (20) is open, the gas generator (16) shows thrust-neutral outflow behaviour.

6. The airbag module according to claim 1, wherein the second outflow opening (20) is closed by a closure element, and the closure element is released from the second outflow opening (20) when the predetermined opening (28) in the wall section (26; 126) is created.

7. The airbag module according to claim 6, wherein the closure element lies between the gas generator (16) and the wall section (26, 126).

8. The airbag module according to claim 5, wherein the closure element is a separate component from the gas generator (16) and the module housing (12).

9. The airbag module according to claim 5, wherein the closure element is plate-shaped.

10. The airbag module according to claim 5, wherein the closure element is in the form of a plug (24).

11. The airbag module according to claim 5, wherein the closure element is made from a plastic material.

12. The airbag module according to claim 5, wherein a softening or a melting of the closure element occurs under the conditions of a bonfire test.
